(19) United States
(12) Patent Application Publication
(10) Pub. No.: US 2024/0253142 A1
(43) Pub. Date: Aug. 1, 2024

(54) LASER SOLDERING APPARATUS, CONTROL APPARATUS, AND LASER SOLDERING METHOD

(71) Applicant: SONY GROUP CORPORATION, TOKYO (JP)

(72) Inventors: HIROYUKI HOSONO, TOKYO (JP); YUTAKA SUGIYAMA, TOKYO (JP); KEIJI JITSUKAWA, TOKYO (JP); KENTARO SAWADA, TOKYO (JP); DAISUKE MOTEKI, TOKYO (JP); YUSUKE KAJIO, TOKYO (JP)

(21) Appl. No.: 18/560,750

(22) PCT Filed: Feb. 17, 2022
(86) PCT No.: PCT/JP2022/006309

§ 371 Date: Nov. 14, 2023

(30) Foreign Application Priority Data
Jun. 2, 2021 (JP) 2021-092980

(51) Int. Cl. B23K 1/005; B23K 26/03; B23K 26/064; B23K 26/073

(52) U.S. Cl. CPC B23K 1/0056; B23K 26/032; B23K 26/064; B23K 26/073

(57) ABSTRACT

To provide a laser soldering apparatus, a control apparatus, and a laser soldering method that are capable of performing high-quality soldering by laser irradiation. A laser soldering apparatus according to the present technology includes a laser light source, a spatial light modulator (SLM), and a control unit. The laser light source emits laser light. The SLM modulates the laser light incident from the laser light source and irradiates at least one of a solder or a soldering target object with the laser light. The control unit controls the laser light source and the SLM to adjust an irradiation condition of the laser light.

### TECHNICAL FIELD

The present technology relates to a laser soldering apparatus, a control apparatus, and a laser soldering method that perform soldering with laser.

### BACKGROUND ART

Laser soldering apparatuses that melt solder and perform soldering by laser light irradiation are often used. In conventional laser soldering apparatuses, a spot shape and a spot size of laser light are fixed, and a general spot shape is a circular one. Meanwhile, some laser soldering apparatuses in which a spot shape and an irradiation spot size are variable have also been developed.

For example, Patent Literature 1 discloses a laser reflow apparatus, which includes a plurality of masks and can change a spot shape by switching the mask on which laser light is incident. Further, Patent Literature 2 discloses an optical device, which includes a pair of plate-shaped optical elements and can change a spot shape by displacing relative positions of the plate-shaped optical elements to cause the laser light to be incident thereon.

### CITATION LIST

### Patent Literature

Patent Literature 1: Japanese Patent Application Laid-open No. 2010-010196
Patent Literature 2: Japanese Patent Application Laid-open No. 2015-200732

### DISCLOSURE OF INVENTION

### Technical Problem

However, in the apparatuses as described in Patent Literatures 1 and 2, it takes one second or more to switch the spot shape. In general, in soldering, heating conditions of solder are adjusted according to a molten state of the solder or the like, which makes it possible to perform high-quality soldering. However, the laser soldering apparatuses have required time to switch the spot shape and have had difficulty of performing such an adjustment in real time.

In view of the circumstances as described above, it is an object of the present technology to provide a laser soldering apparatus, a control apparatus, and a laser soldering method that are capable of performing high-quality soldering by laser irradiation.

### Solution to Problem

In order to achieve the above object, a laser soldering apparatus according to an embodiment of the present technology includes a laser light source, a spatial light modulator (SLM), and a control unit. The laser light source emits laser light.

The SLM modulates the laser light incident from the laser light source and irradiates at least one of a solder or a soldering target object with the laser light.

The control unit controls the laser light source and the SLM to adjust an irradiation condition of the laser light.

The SLM may be a liquid crystal on silicon-SLM (LCOS-SLM).

The control unit may control the SLM to adjust at least one of a spot shape, a spot size, or an intensity distribution of the laser light.

The control unit may control the laser light source to adjust at least one of an output of the laser light, an irradiation time of the laser light, or a profile of the laser light.

The laser soldering apparatus may further include a sensor that senses at least one of the solder, the soldering target object, or a spot of the laser light, and the control unit may adjust the irradiation condition on the basis of a sensing result provided by the sensor.

The control unit may compare the sensing result provided by the sensor with a database, and may specify the irradiation condition.

The sensor may be an image sensor and may sense at least one of a position, a shape, or a color of the solder or the soldering target object.

The sensor may be a temperature sensor and may sense a temperature of the solder or the soldering target object.

The sensor may be a photodetector and may sense the spot of the laser light.

The sensor may perform sensing before irradiation with the laser light and during irradiation with the laser. The control unit may determine the irradiation condition on the basis of a sensing result provided by the sensor before irradiation with the laser light, and may correct the irradiation condition on the basis of a sensing result provided by the sensor during irradiation with the laser light.

The control unit may perform preheating in which the solder is not melted by the laser light, and main heating in which the solder is heated and melted by the laser light.

In order to achieve the above object, a control apparatus according to an embodiment of the present technology includes a control unit.

The control unit controls a laser light source that emits laser light, and a spatial light modulator (SLM) that modulates the laser light incident from the laser light source and irradiates at least one of a solder or a soldering target object with the laser light, to adjust an irradiation condition of the laser light.

In order to achieve the above object, a laser soldering method according to an embodiment of the present technology includes: emitting laser light from a laser light source; modulating, by a spatial light modulator (SLM), the laser light incident from the laser light source and irradiating at least one of a solder or a soldering target object with the laser light; and controlling the laser light source and the SLM to adjust an irradiation condition of the laser light.

### BRIEF DESCRIPTION OF DRAWINGS

FIG. 1 is a schematic view of a laser soldering apparatus according to an embodiment of the present technology.

FIG. 2 is a block diagram of the laser soldering apparatus according to the embodiment of the present technology.

FIG. 3 is a plan view of a spot of laser light that is emitted from the laser soldering apparatus according to the embodiment of the present technology.

FIG. 4 is a flowchart showing an operation of the laser soldering apparatus according to the embodiment of the present technology.

FIG. 5 is a schematic view showing an operation of the laser soldering apparatus according to the embodiment of the present technology.

FIG. 6 is a schematic view showing an operation of the laser soldering apparatus according to the embodiment of the present technology.

FIG. 7 is a schematic view of a laser soldering apparatus having a conventional structure.

FIG. 8 is a plan view of a spot of laser light that is emitted from the laser soldering apparatus having the conventional structure.

FIG. 9 is a plan view of a spot of the laser light that is emitted from the laser soldering apparatus having the conventional structure.

FIG. 10 is a plan view of a spot of the laser light that is emitted from the laser soldering apparatus having the conventional structure.

FIG. 11 is a schematic view showing a Manhattan phenomenon by the laser soldering apparatus having the conventional structure.

FIG. 12 is a schematic view of a component including a plurality of component-side terminals.

FIG. 13 is a schematic view of the component including the plurality of component-side terminals, which is soldered by the laser soldering apparatus having the conventional structure.

FIG. 14 is a schematic view showing three-dimensional mounting of components by the laser soldering apparatus according to the embodiment of the present technology.

FIG. 15 is a schematic view showing an irradiation pattern of the laser light by the laser soldering apparatus according to the embodiment of the present technology.

FIG. 16 is a graph showing a transition of output of the laser light in preheating and main heating performed by the laser soldering apparatus according to the embodiment of the present technology.

FIG. 17 is a schematic view showing solders and a spot in the preheating performed by the laser soldering apparatus according to the embodiment of the present technology.

FIG. 18 is a schematic view showing solders and spots in the main heating performed by the laser soldering apparatus according to the embodiment of the present technology.

FIG. 19 is a schematic view showing another configuration of the laser soldering apparatus according to the embodiment of the present technology.

FIG. 20 is a schematic view showing another configuration of the laser soldering apparatus according to the embodiment of the present technology.

FIG. 21 is a schematic view showing irradiation with laser light by the laser soldering apparatus according to the embodiment of the present technology.

FIG. 22 is a schematic view showing irradiation with laser light by the laser soldering apparatus having the conventional structure.

FIG. 23 is a schematic view showing irradiation with laser light by a laser soldering apparatus including a plurality of SLMs according to the embodiment of the present technology.

FIG. 24 is a schematic view showing irradiation with laser light by a laser soldering apparatus including a single SLM according to the embodiment of the present technology.

FIG. 25 is a block diagram showing a hardware configuration of a control apparatus included in the laser soldering apparatus according to the embodiment of the present technology.

### MODE (S) FOR CARRYING OUT THE INVENTION

A laser soldering apparatus according to an embodiment of the present technology will be described.

### [Configuration of Laser Soldering Apparatus]

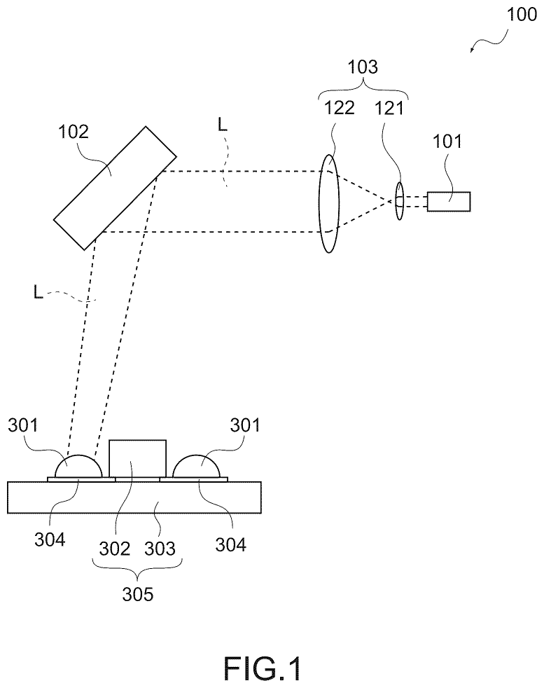

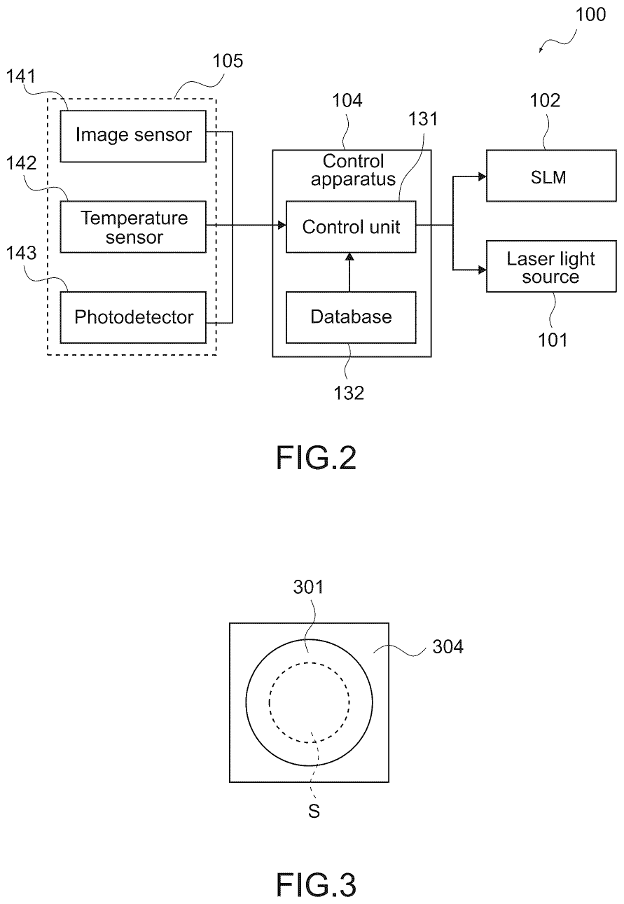

FIG. 1 is a schematic view showing a configuration of a laser soldering apparatus 100 according to this embodiment. FIG. 2 is a block diagram showing a configuration of the laser soldering apparatus 100. As shown in FIGS. 1 and 2, the laser soldering apparatus 100 includes a laser light source 101, an SLM 102, an optical system 103, a control apparatus 104, and a sensor 105. Further, FIG. 1 shows a solder 301, a component 302, and a substrate 303. The substrate 303 includes a substrate-side terminal 304, and the component 302 is joined to the substrate-side terminal 304 by the solder 301. Hereinafter, the component 302 and the substrate 303 will be collectively referred to as a soldering target object 305.

The laser light source 101 emits laser light. In FIG. 1, laser light emitted from the laser light source 101 is represented as laser light L. A wavelength of the laser light L is not particularly limited, but the wavelength is, for example, in a near infrared light band of 800 nm or more and 980 nm or less. The laser light source 101 can be a laser light source having a general configuration.

The spatial light modulator (SLM) 102 modulates a spatial distribution of the laser light L that is incident from the laser light source 101, and emits the laser light L. The spatial distribution includes the amplitude, phase, and polarization of the laser light, and the SLM 102 modulates at least one of them. The SLM 102 can be a liquid crystal on silicon-SLM (LCOS-SLM) including liquid crystal disposed on a silicon substrate. The LCOS-SLM is a reflective SLM that modulates and reflects incident light. Further, the SLM 102 may be an SLM other than the LCOS-SLM.

The SLM 102 irradiates at least one of the solder 301 or the soldering target object 305 with the laser light L. FIG. 1 shows the laser light L with which the solder 301 is irradiated. FIG. 3 is a plan view showing a spot S that is an irradiation spot of the laser light L, and is a view showing the solder 301 and the like from a direction perpendicular to the substrate 303. The spot S may be circular as shown in FIG. 3, or may have another shape such as a rectangle.

The optical system 103 imparts a predetermined optical action to the laser light L. As shown in FIG. 1, the optical system 103 includes a lens 121 and a collimator lens 122, and enlarges a beam diameter of the laser light L and causes the laser light L to enter the SLM 102. The configuration of the optical system 103 is not limited to that shown herein, and may include a mirror or an objective lens to be described later.

The control apparatus 104 (see FIG. 2) is an information processing apparatus that controls the laser soldering apparatus 100. The control apparatus 104 may be integrated with the laser soldering apparatus 100 or may be connected to the laser soldering apparatus 100 directly or via a network. As shown in FIG. 2, the control apparatus 104 includes a control unit 131 and a database 132. Note that the control unit 131 is a functional configuration obtained by cooperation with hardware and software to be described later.

The control unit 131 controls the laser light source 101 and the SLM 102. Specifically, the control unit 131 controls the SLM 102 to adjust at least one of the shape of the spot S, the size of the spot S, or the intensity distribution of the laser light L in the spot S. Further, the control unit 131 controls the laser light source 101 to adjust at least one of the output of the laser light L, an irradiation time of the laser light L, or the profile of the laser light L (change in gradient of output with respect to time).

The database 132 holds a relationship between a sensing result of the sensor 105 and an adjustment value. The control unit 131 compares the sensing result of the sensor 105 with the database 132, and acquires an adjustment value corresponding to the sensing result. The control unit 131 can control the laser light source 101 and the SLM 102 as described above in accordance with the adjustment value.

The sensor 105 (see FIG. 2) senses at least one of the solder 301, the soldering target object 305, or the spot S and outputs a sensing result to the control unit 131. The sensor 105 includes an image sensor 141, a temperature sensor 142, and a photodetector 143.

The image sensor 141 includes a camera and an image processing unit, and senses at least one of a position, a shape, or an color of the solder 301 and the soldering target object 305. Specifically, the image sensor 141 senses a position, a shape, a color, and a state of dirt or deposit of conductor (including substrate-side terminal 304) and insulator patterns of the substrate 303; a position, a shape, a color, and a state of dirt or deposit of a terminal of the component 302; and a position, a shape, a color, a molten state, and the like of the solder 301. The molten state of the solder 301 can be sensed by utilizing a change in grain feeling or a change in gloss of the solder 301. The temperature sensor 142 senses a temperature of the conductor and insulator patterns of the substrate 303, a temperature of the terminal of the component 302, a temperature of the solder 301, and the like. The photodetector 143 senses the shape and size of the spot S. The sensor 105 may include a sensor capable of sensing at least one of the solder 301, the soldering target object 305, or the spot S, in addition to or instead of the image sensor 141, the temperature sensor 142, and the photodetector 143.

### [Operation of Laser Soldering Apparatus]

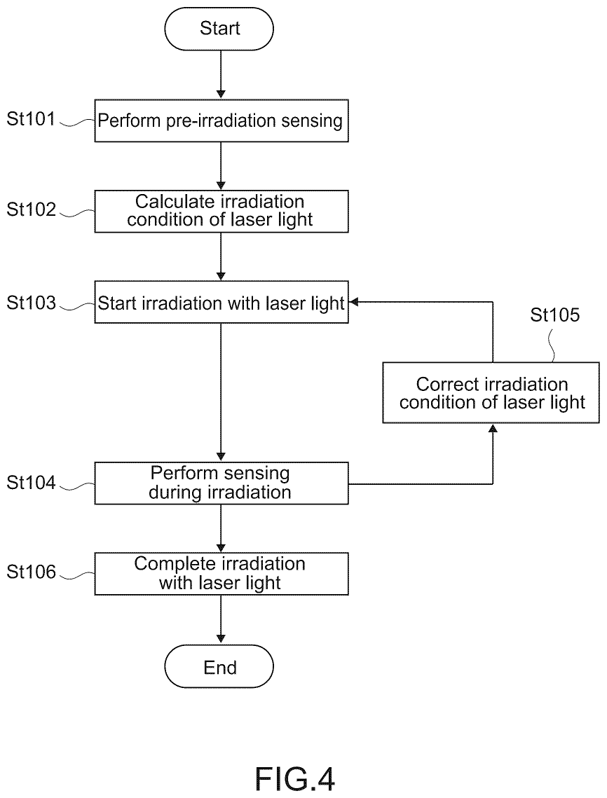

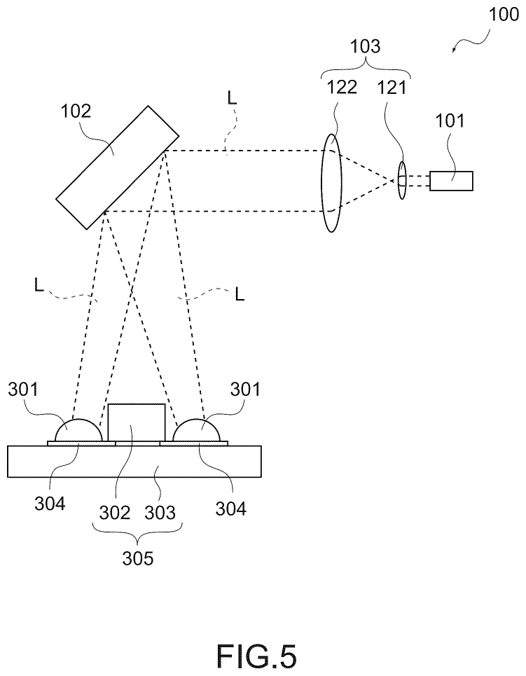

An operation of the laser soldering apparatus 100 will be described. FIG. 4 is a flowchart showing an operation of the laser soldering apparatus 100. FIG. 5 is a schematic view showing an operation of the laser soldering apparatus 100.

As shown in FIG. 4, when soldering is started, the sensor 105 performs pre-irradiation sensing before irradiation with the laser light L (St101). In the pre-irradiation sensing, the image sensor 141 senses a position, a shape, a color, and a state of dirt or deposit of the conductor and insulator patterns of the substrate 303; a position, a shape, a color, and a state of dirt or deposit of the terminal of the component 302; and a position, a shape, a color, and the like of the solder 301. The temperature sensor 142 senses the temperature of the conductor and insulator patterns of the substrate 303, the temperature of the terminal of the component 302, the temperature of the solder 301, and the like. The image sensor 141 and the temperature sensor 142 output those sensing results to the control unit 131.

The control unit 131 calculates an irradiation condition of the laser light L in accordance with those sensing results (St102). Specifically, the control unit 131 compares the sensing results with the database 132 and specifies adjustment values corresponding to the sensing results of the respective sensors. The control unit 131 acquires, as adjustment values, a size of the spot S, a shape of the spot S, an intensity distribution of the laser light L in the spot S, an output of the laser light L, an irradiation time of the laser light L, and a profile of the laser light L.

The control unit 131 controls the laser light source 101 and the SLM 102 in accordance with the acquired adjustment values, and starts irradiation with the laser light L (St103). After the irradiation with the laser light L is started, the sensor 105 performs sensing during irradiation (St104). In the sensing during irradiation, the image sensor 141 senses a position, a shape, a color, and a state of dirt or deposit of the conductor and insulator patterns of the substrate 303; a position, a shape, a color, and a state of dirt or deposit of the terminal of the component 302; and a position, a shape, a color, a molten state, and the like of the solder 301. The temperature sensor 142 senses the temperature of the conductor and insulator patterns of the substrate 303, the temperature of the terminal of the component 302, the temperature of the solder 301, and the like. The photodetector 143 senses the shape and size of the spot S. The image sensor 141, the temperature sensor 142, and the photodetector 143 output those sensing results to the control unit 131.

The control unit 131 corrects the irradiation condition of the laser light L in accordance with those sensing results (St105). Specifically, the control unit 131 compares the sensing results with the database 132 and acquires adjustment values corresponding to the sensing results of the respective sensors. The control unit 131 acquires, as adjustment values, a size of the spot S, a shape of the spot S, an intensity distribution of the laser light L in the spot S, an output of the laser light L, an irradiation time of the laser light L, and a profile of the laser light L.

The control unit 131 controls the laser light source 101 and the SLM 102 in accordance with the acquired adjustment values, and continues irradiation with the laser light L after correcting the irradiation condition of the laser light L (St103). After that, the control unit 131 repeats the irradiation with the laser light L (St103), the sensing during irradiation (St104), and the correction of the irradiation condition (St105). The control unit 131 completes the irradiation with the laser light L when the sensing results of the sensor 105 satisfy a predetermined completion condition (St106).

The laser soldering apparatus 100 performs irradiation with the laser light L as described above. The solder 301 is heated by the laser light L (see FIG. 1) and melted to join the component 302 and the substrate-side terminal 304 to each other. Thus, the component 302 is soldered to the substrate 303. Further, the laser light source 101 and the SLM 102 are controlled in accordance with the sensing results provided by the sensor 105, so that the irradiation condition of the laser light L is adjusted. Note that, when there is a plurality of portions to be soldered, as shown in FIG. 5, the control unit 131 can switch the reflection angle of the SLM 102 to simultaneously irradiate the plurality of portions to be soldered with the laser light L and simultaneously heat a plurality of 301 with a plurality of beams. If the SLM 102 is an LCOS-SLM, a switching time is approximately 20 msec, and high-speed switching is possible.

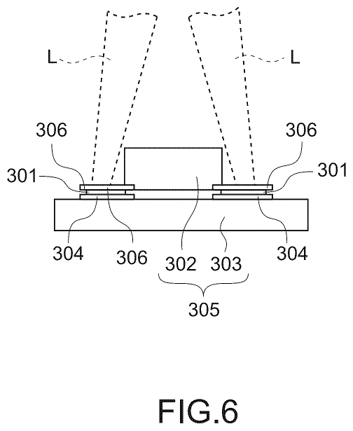

Note that, in the above description, the laser light L is used to irradiate the solder 301, but the present technology is not limited thereto. FIG. 6 is a schematic view showing the laser light L used to irradiate a terminal. As shown in the figure, the component 302 may include a component-side terminal 306, and the solder 301 may be disposed between the component-side terminal 306 and the substrate-side terminal 304. In this case, the laser light L is emitted to the component-side terminal 306 and melts the solder 301 via the component-side terminal 306. In the present disclosure, the description in which the laser light L is emitted to the solder 301 can be replaced with a description in which the laser light L is emitted to the component-side terminal 306. In addition, the laser light L only needs to be emitted to at least one of a solder joint terminal included in the soldering target object 305 or the solder 301.

### [Effects of Laser Soldering Apparatus]

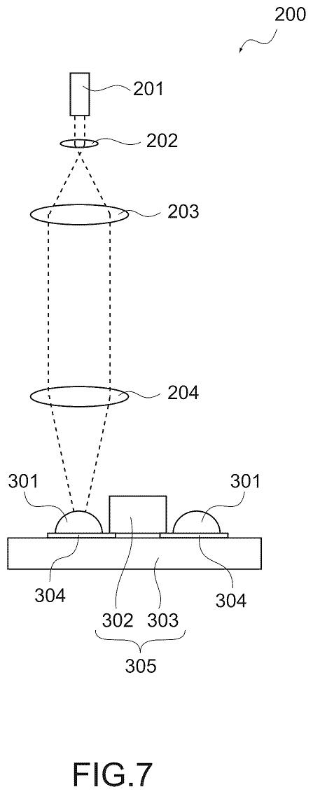

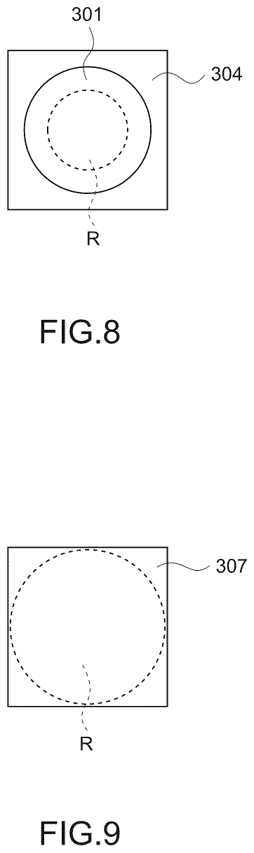

The effects provided by the laser soldering apparatus 100 will be described in comparison with a conventional laser soldering apparatus. FIG. 7 is a schematic view of a conventional laser soldering apparatus 200. As shown in the figure, the laser soldering apparatus 200 includes a laser light source 201, a lens 202, a collimator lens 203, and an objective lens 204. Laser light M emitted from the laser light source 201 enters the solder 301 via the lens 202, the collimator lens 203, and the objective lens 204. FIG. 8 is a plan view showing a spot R that is an irradiation spot of the laser light M, and is a view of the solder 301 or the like viewed from a direction perpendicular to the substrate 303.

In the laser soldering apparatus 200, the shape and size of the spot R are fixed, and irradiation is generally performed on only one circular point. There are some devices in which the shape and size of the spot R are variable, but a diameter of the spot R is merely changed, and the fastest switching time is as slow as one second or more. This makes it difficult to perform correction in real time.

Further, a site to be irradiated with the laser light M in the soldering includes a conductor pattern and an insulator pattern (solder resist or the like) on the substrate 303, constituent elements of the component 302 such as a terminal, and the solder 301. The shapes, sizes, and relative positions thereof are not uniform depending on a component to be soldered. Further, those shapes, sizes, and relative positions vary within a certain range in each operation.

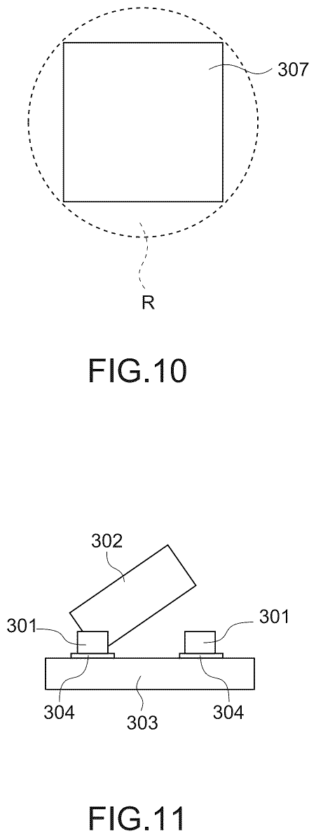

For example, it is assumed that the laser soldering apparatus 200 irradiates a conductor pattern having a quadrangular shape with laser light having a circular spot R. FIGS. 9 and 10 are schematic views each showing a conductor pattern 307 having a quadrangular shape and a spot R. As shown in FIG. 9, when the laser light M is emitted such that the spot R becomes an incircle of the conductor pattern 307 having a quadrangular shape, it takes time until corner portions of the conductor pattern 307, to which the laser light M is not emitted, are heated. This deteriorates wetting and spreading of the solder and is thus likely to cause problems such as unmelted solder. On the other hand, as shown in FIG. 10, when the laser light M is emitted such that the spot R becomes a circumcircle of the conductor pattern 307 having a quadrangular shape, the laser light M will be emitted to an insulator portion around the conductor pattern 307, and there is a possibility of damaging the substrate 303, such as burning in that portion.

Further, when a small chip component is soldered by the laser soldering apparatus 200, the following problems arise. FIG. 11 is a schematic view showing soldering of a component 302 that is a small chip component. If all the terminals of the small chip component (mainly two terminals) are not uniformly heated, a phenomenon (Manhattan phenomenon) occurs, in which the chip stands as shown in FIG. 11. In the laser soldering apparatus 200, the beam of the laser light M is one, and thus when the plurality of terminals is simultaneously heated, not only the terminals but also the entire component 302 are heated, and damage to the component 302, a surrounding substrate material, or the like is inevitable.

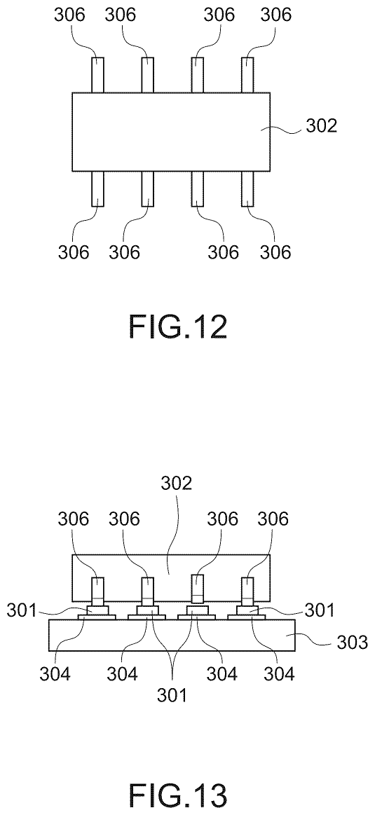

Further, also when a component including a plurality of terminals, such as an integrated circuit (IC), is soldered by the laser soldering apparatus 200, the following problems arise. FIG. 12 is a schematic view showing a component 302 including a plurality of component-side terminals 306. FIG. 13 is a schematic view showing soldering of the component 302. When the component 302 including the plurality of component-side terminals 306 is soldered, if the component-side terminals 306 are heated one by one, a heated component-side terminal 306 on which the solder 301 is melted, and an unheated component-side terminal 306 have different heights due to the solders 301. Thus, there is a possibility that the solder 301 does not reach any of the component-side terminal 306 and the substrate-side terminal 304 as shown in FIG. 13, and the connection fails. This is particularly pronounced in components with poor coplanarity (uniformity of terminal shape).

In addition, since the temperature of the solder 301 rapidly rises in the soldering by the laser soldering apparatus 200, bumping of the solder material is likely to occur. This easily causes quality problems such as generation of solder balls (small molten solders that are spattered and adhere to the periphery). Further, in general soldering, preheating may be performed in advance in order to stably perform soldering. However, preheating cannot be performed only by the laser soldering apparatus 200, and thus it is necessary to separately prepare an apparatus for preheating.

Further, temperature sensing using a radiation thermometer is generally performed as sensing of a state during soldering using the laser light. However, there is also a problem that accurate measurement of a temperature is difficult to perform with the radiation thermometer. In the radiation thermometer, a correlation coefficient between an actual temperature and an output value of the thermometer varies depending on the emissivity of an object to be measured. In the case of soldering, the conductor pattern and the insulator pattern on the substrate 303, the terminal of the component 302, the solder 301, and the like are close to each other, which makes it difficult to set only a specific site among them as an object to be measured. Further, since the emissivity changes before and after the solder 301 melts, accurate measurement of the temperature cannot be performed.

In contrast to the above, in the laser soldering apparatus 100 according to this embodiment, the control unit 131 controls the laser light source 101 and the SLM 102 to adjust the size of the spot S (see FIG. 3), the shape of the spot S, the intensity distribution of the laser light L in the spot S, the output of the laser light L, the irradiation time of the laser light L, and the profile of the laser light L. Thus, the laser soldering apparatus 100 can emit the laser light L under a suitable irradiation condition, and can perform high-quality soldering. Further, the control unit 131 adjusts the irradiation condition on the basis of the sensing results provided by the sensor 105, which makes it possible to adjust the irradiation condition of the laser light L according to the conductor pattern and the insulator pattern on the substrate 303 (see FIG. 1), the arrangement of the component-side terminal 306 and the solder 301, the temperatures thereof, the shape of the spot S, and the like. In addition, the control unit 131 can correct the irradiation condition of the laser light L according to the sensing results even during the irradiation of the laser light L, and can set a suitable irradiation condition according to the state of each site.

Further, in the laser soldering apparatus 100, when a small chip component (see FIG. 11) is soldered, the terminals on both sides can be heated at the same time. This makes it possible to prevent occurrence of a phenomenon (Manhattan phenomenon) in which the component 302 stands. Further, in the laser soldering apparatus 100, when a component 302 (see FIG. 12) including a plurality of component-side terminals 306, such as an IC, is soldered, all the terminals can be simultaneously heated. Thus, the solders 301 for all the terminals are simultaneously melted, and at the same time, the component 302 sinks down. This can suppress a defect, e.g., the solder 301 does not reach the component-side terminal 306. Therefore, a component having poor coplanarity can also be suitably soldered.

In addition, in the laser soldering apparatus 100, the laser light L can be emitted at a place where the solder 301 (see FIG. 1) is disposed. This makes it possible to suppress the bumping of the solder 301. Further, this also makes it possible to suppress a defect such as an unmelted portion that remains in the solder 301. If the solder 301 is a cream solder, the solder 301 is crushed when a component is disposed on the solder 301, but the crushed shape is different every time. In the laser soldering apparatus 100, it is possible to recognize the crushed shape and match the shape and size of the spot S to the crushed shape, thus preventing the solder 301 from remaining unmelted.

Further, in the laser soldering apparatus 100, it is possible to simultaneously solder a plurality of components or a plurality of terminals (see FIG. 5) and improve productivity. Further, the laser intensity of each of the plurality of beams of the laser light L can be discretionally set, so that it is possible to equalize the time required for soldering when the plurality of components is simultaneously heated, and also possible to improve the productivity accordingly.

In addition, in the laser soldering apparatus 100, laser light L having a spot shape suitable for a place to be heated can be emitted. Thus, damage to the surrounding members can be reduced, so that the present technology can be applied to a low-heat-resistant substrate.

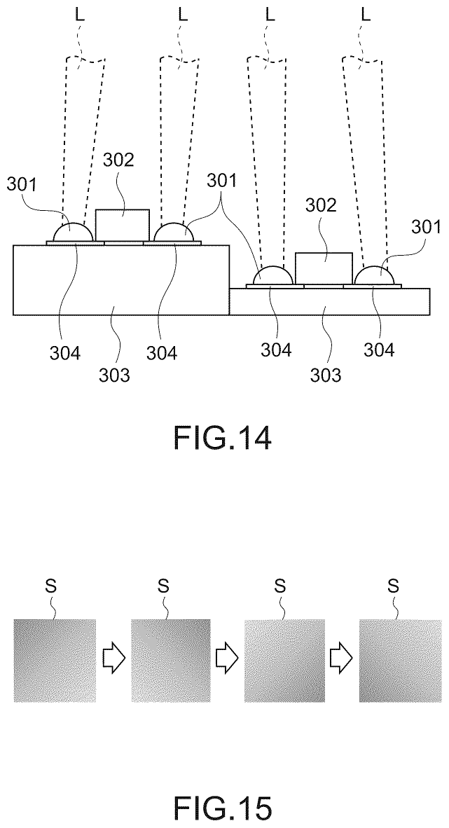

Further, the laser soldering apparatus 100 can support three-dimensional mounting. FIG. 14 is a schematic view showing three-dimensional mounting by the laser soldering apparatus 100. In the laser soldering apparatus 100, the focus of the laser light L can be changed in real time by the SLM 102, and as shown in FIG. 14, portions having different heights can be simultaneously heated. This makes it possible to mount a plurality of components 302 three-dimensionally. Some laser soldering apparatuses are of a galvano type in which scanning of laser light is performed using a galvano mirror. However, in this type, it is difficult to change the focus in real time, and thus it is impossible to simultaneously heat the portions having different heights.

Further, in the laser soldering apparatus 100, an increase in power of the laser light L can be performed. Since scanning of laser light is performed in the galvano type, it is impossible to give a high heat quantity in a short time. However, the SLM 102 can perform collective irradiation and increase the power of the laser light L. Further, in the laser soldering apparatus 100, the in-plane uniformity of the laser light L can be improved. If the SLM is used, an intensity distribution of a surface irradiated with the laser light can be discretionally set. For that reason, the in-plane uniformity can be corrected. FIG. 15 is a schematic view showing an irradiation pattern of the laser light L, and shows an intensity distribution of the laser light L at the spot S in gray scale. In the laser soldering apparatus 100, switching a plurality of irradiation patterns at high speed as shown in FIG. 15 makes it possible to uniformly heat the inside of a processing surface.

Further, in the laser soldering apparatus 100, not only the temperature but also the state of soldering are sensed using the image sensor 141 (see FIG. 2). This makes it possible to capture the moment when the solder 301 melts (the grain feeling of the solder paste disappears), capture the moment when the solder 301 is wet and spread, capture the moment when the solder 301 melts and the component 302 sinks down, and capture a change in color and gloss of the member due to heating, for example. Thus, soldering in which damage to the members is suppressed can be performed more efficiently.

### [Regarding Preheating]

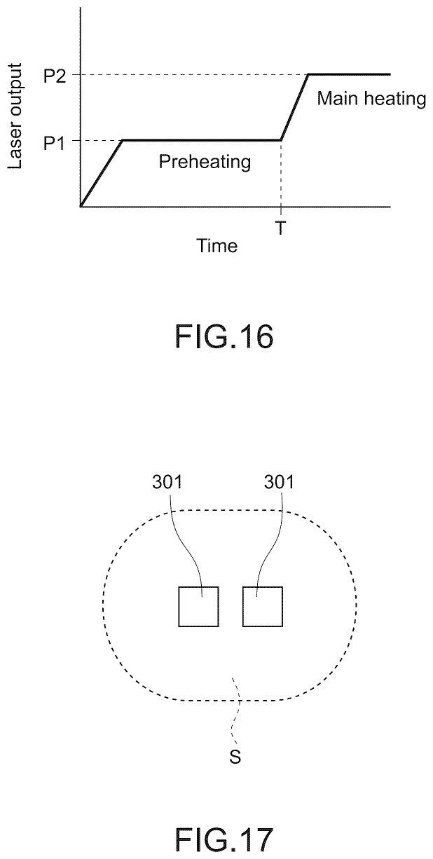

In the laser soldering apparatus 100, it is possible to perform preheating in which the solder 301 is not melted, before performing main heating in which the solder 301 (see FIG. 1) is melted. FIG. 16 is a graph showing a transition of the output of the laser light L in the preheating and the main heating. As shown in the figure, the control unit 131 emits the laser light L with the output of the laser light source 101 as an output P1, to perform preheating. FIG. 17 is a schematic view showing solders 301 and a spot S in the preheating. As shown in the figure, the control unit 131 controls the SLM 102 such that the spot S has a wide range including the periphery of the solders 301. The output P1 is an output that heats the solders 301 to a temperature at which the solders 301 are not melted.

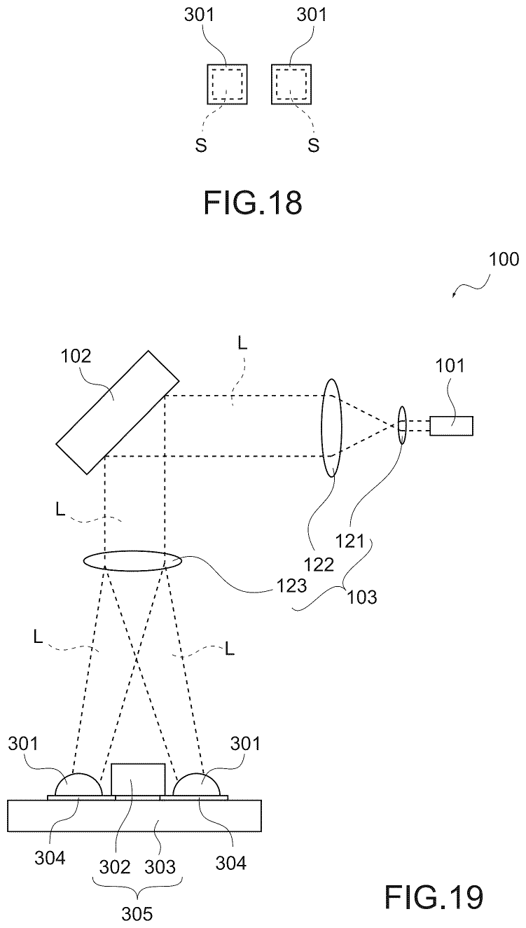

In addition, as shown in FIG. 16, the control unit 131 emits the laser light L with the output of the laser light source 101 as an output P2, to perform main heating. FIG. 18 is a schematic view showing the solders 301 and the spots S in the main heating. As shown in the figure, the control unit 131 controls the SLM 102 such that the spot S has a range narrower than the solder 301. The output P2 is an output that heats the solder 301 to a temperature at which the solder 301 is melted.

As described above, in the laser soldering apparatus 100, the preheating and the main heating can be switched depending on the output of the laser light source 101 and the range of the spot S. Since the preheating can be performed only by the laser soldering apparatus 100, equipment costs can be suppressed.

### [Regarding Other Configurations of Laser Soldering Apparatus]

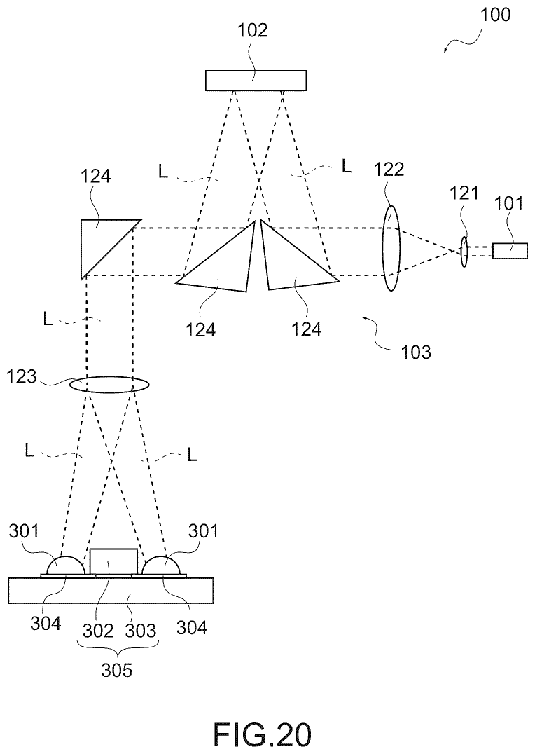

Other configurations of the laser soldering apparatus 100 will be described. FIGS. 19 and 20 are schematic views showing other configurations of the laser soldering apparatus 100. As shown in FIG. 19, the optical system 103 may include an objective lens 123 on which the laser light L emitted from the SLM 102 is incident. Further, as shown in FIG. 20, the optical system 103 may include a plurality of mirrors 124 that reflects the laser light L. In addition to those configurations, the laser soldering apparatus 100 may include optical systems 103 having various configurations.

### [Regarding Irradiation Direction of Laser Light]

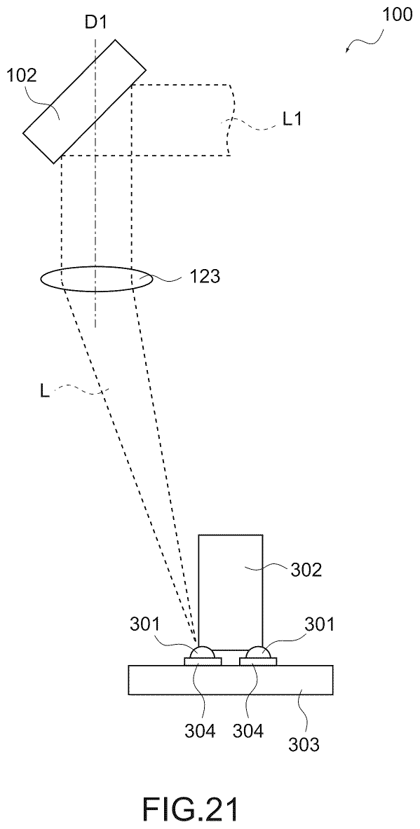

The laser soldering apparatus 100 includes the SLM 102, so that an irradiation direction of the laser light L can be set in the following manner. FIG. 21 is a schematic view showing an irradiation direction of the laser light L emitted by the laser soldering apparatus 100. As shown in the figure, in the laser soldering apparatus 100, use of the SLM 102 makes it possible to emit the laser light L to the solder 301 from an oblique direction while an optical axis D1 of the laser light L is kept perpendicular to the main surface of the substrate 303.

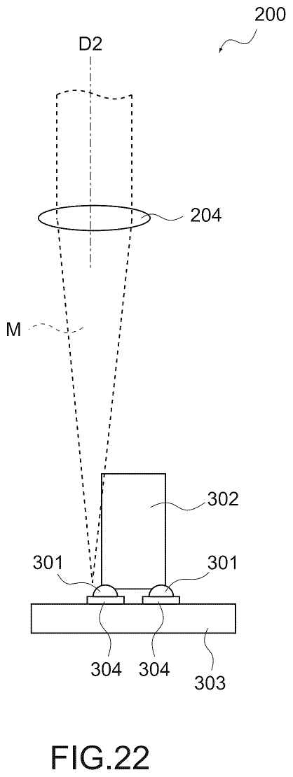

On the other hand, FIG. 22 is a schematic view showing the irradiation direction of the laser light M emitted by the conventional laser soldering apparatus 200 (see FIG. 7). As shown in the figure, in the laser soldering apparatus 200, an optical axis D2 of the laser light M is perpendicular to the main surface of the substrate 303, and the same applies to a general laser soldering apparatus. In this case, there are problems that the laser light M interferes with a tall component 302 and that the solder 301 does not receive sufficient laser light M.

In this regard, in the laser soldering apparatus 100, the laser light L can be emitted at an angle at which the interference with the component 302 is avoided. This makes it possible to avoid damaging the component 302 due to the irradiation of the laser light L, and to emit the laser light L to the solder 301 close to the component 302, so that reliable soldering can be achieved.

### [Regarding Laser Soldering Apparatus Including Plurality of SLMs]

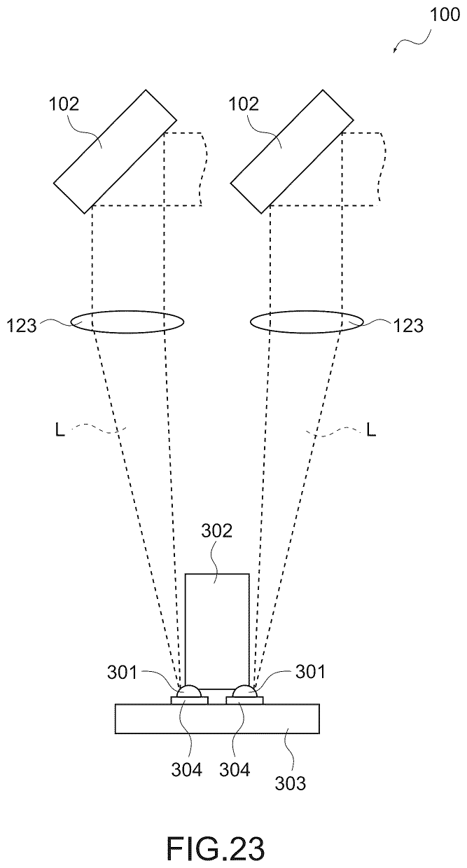

The laser soldering apparatus 100 may include a plurality of SLMs 102. FIG. 23 is a schematic view showing irradiation of laser light L by a laser soldering apparatus 100 including a plurality of SLMs 102. As shown in the figure, the laser soldering apparatus 100 includes two SLMs 102, and a solder 301 can be irradiated with the laser light L emitted from each SLM 102. Note that the number of SLMs 102 included in the laser soldering apparatus 100 is not limited to two, and may be three or more. Further, the laser soldering apparatus 100 may include a plurality of laser light sources 101 for causing the laser light L to enter the respective SLMs 102, or may include a single laser light source 101 for causing the laser light L to enter the plurality of SLMs 102.

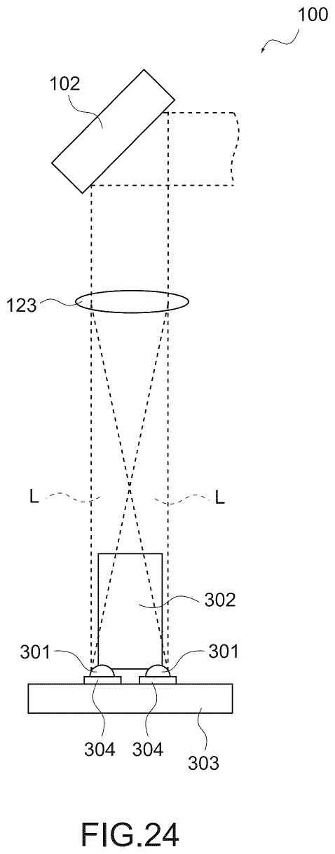

FIG. 24 is a schematic view showing irradiation of laser light L by a laser soldering apparatus 100 including a single SLM 102. As shown in the figure, when a tall component 302 is soldered by the laser soldering apparatus 100, there arise problems that the laser light L hits the component 302, a heat-resistant temperature of the component 302 is exceeded, burning is generated in the component 302, the solder 301 is not sufficiently melted, and thus a soldering failure occurs.

In this regard, as shown in FIG. 23, the laser soldering apparatus 100 includes the plurality of SLMs 102, so that the solders 301 can be irradiated with beams of the laser light L from the respective SLMs 102 without interfering with the component 302. Even if the laser soldering apparatus 100 includes a single SLM 102, the shape of the spot S can be manipulated, but a controllable irradiation angle of the laser light L is limited. Here, if the laser soldering apparatus 100 includes a plurality of SLMS 102, it is possible to avoid the limitation of the irradiation angle.

If the laser soldering apparatus 100 includes a plurality of SLMs 102 as described above, the soldering quality and reliability can be improved. Specifically, irradiation with the laser light L can be performed at an angle at which an interference with the component 302 is avoided, and generation of burning of the component 302 can be avoid. Further, it is possible to emit laser light L having effective energy to an operation surface of the soldering, and reduce soldering failures. In addition, if the laser soldering apparatus 100 includes a single laser light source 101, the laser light L is branched for use. Thus, a thermal load per SLM 102 is reduced, so that the lifetime of the SLM 102 can be extended. Further, if the laser soldering apparatus 100 includes a plurality of laser light sources 101, the total output of the laser light L is increased, and thus the productivity is improved.

### [Hardware Configuration of Control Device]

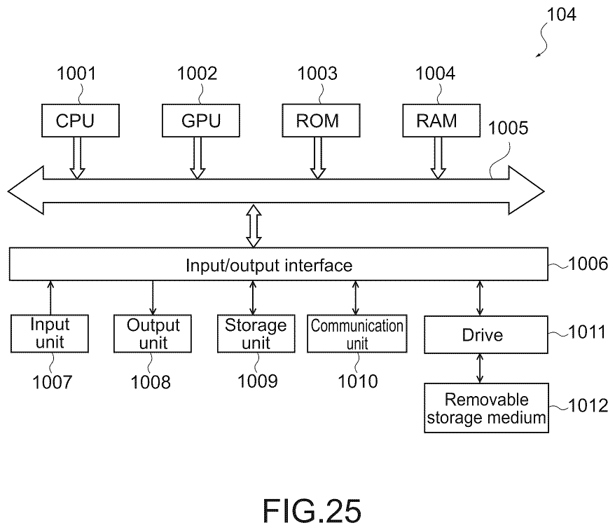

A hardware configuration that makes it possible to implement a functional configuration of the control apparatus 104 will be described. FIG. 25 is a schematic view showing a hardware configuration of the control apparatus 104.

As shown in the figure, the control apparatus 104 includes a central processing unit (CPU) 1001 and a graphics processing unit (GPU) 1002. An input/output interface 1006 is connected to the CPU 1001 and the GPU 1002 via a bus 1005. A read only memory (ROM) 1003 and a random access memory (RAM) 1004 are connected to the bus 1005.

An input unit 1007, an output unit 1008, a storage unit 1009, and a communication unit 1010 are connected to the input/output interface 1006. The input unit 1007 includes input devices such as a keyboard and a mouse that are used by a user to input an operation command. The output unit 1008 outputs a processing operation screen and an image of a processing result to a display device. The storage unit 1009 includes, for example, a hard disk drive that stores therein a program and various types of data. The communication unit 1010 includes, for example, a local area network (LAN) adapter, and performs communication processing through a network as represented by the Internet. Further, a drive 1011 is connected to the input/output interface 1006. The drive 1011 reads data from and writes data into a removable storage medium 1012 such as a magnetic disk, an optical disc, a magneto-optical disc, or a semiconductor memory. The database 132 (see FIG. 2) is stored in the storage unit 1009.

The CPU 1001 performs various processes in accordance with a program stored in the ROM 1003, or in accordance with a program that is read from the removable storage medium 1012 such as a magnetic disk, an optical disc, a magneto-optical disc, or a semiconductor memory to be installed on the storage unit 1009, and is loaded into the RAM 1004 from the storage unit 1009. Data necessary for the CPU 1001 to perform various processes is also stored in the RAM 1004 as necessary. The GPU 1002 performs calculation processing necessary to draw an image under the control of the CPU 1001.

In the control apparatus 104 having the configuration described above, the series of processes described above is performed by the CPU 1001 loading, for example, a program stored in the storage unit 1009 into the RAM 1004 and executing the program via the input/output interface 1006 and the bus 1005.

For example, the program executed by the control apparatus 104 can be provided by being recorded in the removable storage medium 1012 serving as, for example, a package medium. Further, the program can be provided via a wired or wireless transmission medium such as a local area network, the Internet, or digital satellite broadcasting.

In the control apparatus 104, the program can be installed on the storage unit 1009 via the input/output interface 1006 by the removable storage medium 1012 being mounted on the drive 1011. Further, the program can be received by the communication unit 1010 via the wired or wireless transmission medium to be installed on the storage unit 1009. Moreover, the program can be installed in advance on the ROM 1003 or the storage unit 1009.

Note that the program executed by the control apparatus 104 may be a program in which processes are chronologically performed in the order of the description in the present disclosure, or may be a program in which processes are performed in parallel or a process is performed at a necessary timing such as a timing of calling.

Further, all of the hardware configuration of the control apparatus 104 does not have to be included in a single apparatus, and the control apparatus 104 may include a plurality of apparatuses. Further, a portion of or all of the hardware configuration of the control apparatus 104 may be included in a plurality of apparatuses connected to each other via a network.

### REGARDING PRESENT DISCLOSURE

The effects described in the present disclosure are merely examples and are not limited, and other effects may be obtained. The above description of the plurality of effects does not necessarily mean that the effects are exerted at the same time. It is meant that at least any one of the effects described above can be obtained depending on the conditions and the like, and there is a possibility that effects not described in the present disclosure can be exhibited. Further, at least two feature portions of the feature portions described in the present disclosure can be discretionally combined with each other.

Note that the present technology may also take the following configurations.
(1) A laser soldering apparatus, including:
   a laser light source that emits laser light;
   a spatial light modulator (SLM) that modulates the laser light incident from the laser light source and irradiates at least one of a solder or a soldering target object with the laser light; and
   a control unit that controls the laser light source and the SLM to adjust an irradiation condition of the laser light.
(2) The laser soldering apparatus according to (1), in which
   the SLM is a liquid crystal on silicon-SLM (LCOS-SLM).
(3) The laser soldering apparatus according to (1) or (2), in which
   the control unit controls the SLM to adjust at least one of a spot shape, a spot size, or an intensity distribution of the laser light.
(4) The laser soldering apparatus according to any one of (1) to (3), in which
   the control unit controls the laser light source to adjust at least one of an output of the laser light, an irradiation time of the laser light, or a profile of the laser light.
(5) The laser soldering apparatus according to any one of (1) to (4), further including
   a sensor that senses at least one of the solder, the soldering target object, or a spot of the laser light, in which
   the control unit adjusts the irradiation condition on the basis of a sensing result provided by the sensor.
(6) The laser soldering apparatus according to (5), in which
   the control unit compares the sensing result provided by the sensor with a database, and specifies the irradiation condition.
(7) The laser soldering apparatus according to (5) or (6), in which
   the sensor is an image sensor and senses at least one of a position, a shape, or a color of the solder or the soldering target object.
(8) The laser soldering apparatus according to (5) or (6), in which
   the sensor is a temperature sensor and senses a temperature of the solder or the soldering target object.
(9) The laser soldering apparatus according to (5) or (6), in which
   the sensor is a photodetector and senses the spot of the laser light.
(10) The laser soldering apparatus according to any one of (5) to (9), in which
   the sensor performs sensing before irradiation with the laser light and during irradiation with the laser, and
   the control unit determines the irradiation condition on the basis of a sensing result provided by the sensor before irradiation with the laser light, and corrects the irradiation condition on the basis of a sensing result provided by the sensor during irradiation with the laser light.
(11) The laser soldering apparatus according to any one of (1) to (10), in which
   the control unit performs preheating in which the solder is not melted by the laser light, and main heating in which the solder is heated and melted by the laser light.
(12) A control apparatus, including
   a control unit that controls
      a laser light source that emits laser light, and
      a spatial light modulator (SLM) that modulates the laser light incident from the laser light source and irradiates at least one of a solder or a soldering target object with the laser light,
   to adjust an irradiation condition of the laser light.
(13) A laser soldering method, including:
   emitting laser light from a laser light source;
   modulating, by a spatial light modulator (SLM), the laser light incident from the laser light source and irradiating at least one of a solder or a soldering target object with the laser light; and
   controlling the laser light source and the SLM to adjust an irradiation condition of the laser light.

### REFERENCE SIGNS LIST

100 laser soldering apparatus
101 laser light source
102 SLM
103 optical system
104 control apparatus
105 sensor
131 control unit
132 database
141 image sensor
142 temperature sensor
143 photodetector
301 solder
302 component
303 substrate
304 substrate-side terminal
305 soldering target object
306 component-side terminal

1. A laser soldering apparatus, comprising:
a laser light source that emits laser light;
a spatial light modulator (SLM) that modulates the laser light incident from the laser light source and irradiates at least one of a solder or a soldering target object with the laser light; and
a control unit that controls the laser light source and the SLM to adjust an irradiation condition of the laser light.

2. The laser soldering apparatus according to claim 1, wherein
the SLM is a liquid crystal on silicon-SLM (LCOS-SLM).

3. The laser soldering apparatus according to claim 1, wherein
the control unit controls the SLM to adjust at least one of a spot shape, a spot size, or an intensity distribution of the laser light.

4. The laser soldering apparatus according to claim 1, wherein
the control unit controls the laser light source to adjust at least one of an output of the laser light, an irradiation time of the laser light, or a profile of the laser light.

5. The laser soldering apparatus according to claim 1, further comprising
a sensor that senses at least one of the solder, the soldering target object, or a spot of the laser light, wherein
the control unit adjusts the irradiation condition on a basis of a sensing result provided by the sensor.

6. The laser soldering apparatus according to claim 5, wherein
the control unit compares the sensing result provided by the sensor with a database, and specifies the irradiation condition.

7. The laser soldering apparatus according to claim 5, wherein
the sensor is an image sensor and senses at least one of a position, a shape, or a color of the solder or the soldering target object.

8. The laser soldering apparatus according to claim 5, wherein
the sensor is a temperature sensor and senses a temperature of the solder or the soldering target object.

9. The laser soldering apparatus according to claim 5, wherein
the sensor is a photodetector and senses the spot of the laser light.

10. The laser soldering apparatus according to claim 5, wherein
the sensor performs sensing before irradiation with the laser light and during irradiation with the laser, and
the control unit determines the irradiation condition on a basis of a sensing result provided by the sensor before irradiation with the laser light, and corrects the irradiation condition on a basis of a sensing result provided by the sensor during irradiation with the laser light.

11. The laser soldering apparatus according to claim 1, wherein
the control unit performs preheating in which the solder is not melted by the laser light, and main heating in which the solder is heated and melted by the laser light.

12. A control apparatus, comprising
a control unit that controls
a laser light source that emits laser light, and
a spatial light modulator (SLM) that modulates the laser light incident from the laser light source and irradiates at least one of a solder or a soldering target object with the laser light,
to adjust an irradiation condition of the laser light.

13. A laser soldering method, comprising:
emitting laser light from a laser light source;
modulating, by a spatial light modulator (SLM), the laser light incident from the laser light source and irradiating at least one of a solder or a soldering target object with the laser light; and
controlling the laser light source and the SLM to adjust an irradiation condition of the laser light.
